(19) United States
(12) Patent Application Publication
(10) Pub. No.: US 2020/0088345 A1
(43) Pub. Date: Mar. 19, 2020

(54) UNIVERSAL SUPPORT AND METHOD FOR INSTALLING THE SAME

(71) Applicant: CARLOS ALBERTO DE ALMEIDA BORGES, RIO DE JANEIRO (BR)

(72) Inventor: CARLOS ALBERTO DE ALMEIDA BORGES, RIO DE JANEIRO (BR)

(21) Appl. No.: 16/573,646

(22) Filed: Sep. 17, 2019

(30) Foreign Application Priority Data
Sep. 18, 2018 (BR) 1020180689525

(51) Int. Cl. F16M 13/02

(52) U.S. Cl. CPC F16M 13/02

(57) ABSTRACT

The present invention refers to a support, metallic or non-metallic, for disposing elements over a coverage (such as walkways, lightning arrester rods, photovoltaic panels, life lines, among other equipment and structures), taking benefit of existing holes in the coverage structure, for transferring the structural capacity to the top face of the coverage, without the need for perforations in the coverage sheet (tile).

### SUMMARY OF INVENTION

The present invention is related to a support, metallic or non-metallic, for the arrangement of elements over a coverage (such as walkways, lightning rods, photovoltaic panels, life lines, among other equipment and structures), taking benefit of existing holes in the coverage structure, for transferring the structural capacity to the top face of the coverage, without the need for perforations in the coverage sheet (tile).

### BACKGROUND OF THE INVENTION

The device of the present invention is directly derived and complements several inventions owned by the applicant, the first configuration having been filed with the INPI on Aug. 21, 1978 (PI 7805402-8), the second on Sep. 9, 1985 (PI 8504326-5), the third on Feb. 5, 1991 (PI 9100456-0), the fourth on Nov. 5, 1993 (PI 9304495-0), the fifth on Mar. 27, 1996 (PI 9601145-9), the sixth on Mar. 23, 2009 (PI 0902183-3), the seventh on Jun. 6, 2016 (BR102016014526-0), and the others in 2017 (BR102017026466-1_870170095549, BR102017026394-0_870170095254 and BR102017026215-4_870170094578), said documents being indicated for the purpose of ascertaining prior art.

Since its launching to nowadays, the system initially revealed, described above, has about 10 million square meters installed, meeting all the demands and technical requirements required by the market.

One of the market demands mentioned above refers to the use of the coverage as support for several elements not related to the structure or coverage such as walkways, miscellaneous equipment, other structures, utilities, air-conditioning equipment, photovoltaic panels, lightning arrester system, lifelines etc.

The first configuration (basic structure) is defined by the pieces 1—Upper/Lower Chord, piece 11—Diagonals of frame, piece 12—Connecting crosspieces, piece 15—Coverage sheet (tile), piece 8—‘joint overlapping’.

At present, to fasten the apparatuses on the coverage, it is common to drill somewhere the coverage sheet or rely on fastening of other existing pieces.

Upon drilling the coverage sheet, it is created a potential leakage, as it is dependent on the seal performed in the hole. Even using good-quality sealing materials, water infiltration may occur over time. This is because over the months the sealing masses lose their main characteristics as adhesion and elasticity, allowing the passage of water.

Upon taking benefit of an existing fastening there may be undesired movements in the bolt or rivet, creating a gap therein with consequent infiltration

As shown in FIGS. 1, 2A and 2B, the coverage sheet (15), which acts as a tile in the coverage structure of the present invention, is resiliently contained between the chord 1 and joint overlapping (8).

This way, the apparatus, whatever it may be, rests on the joint overlapping and in order to fasten it, joint overlapping (8) fastenings are used, or a hole is drilled therein.

In addition to the above, because the joint overlapping is not a structural piece, it is made of very thin sheet, 0.65 mm, the placing of a thicker piece of sheet between 1.11 and 2.70 mm between it and the chord is mandatory to prevent deformation thereof.

The present invention is a piece developed based on the following concepts:
to be secured to a structural element, preferably the chord (1),
to have a geometry that allows installation of joint overlapping thereon, and
to have enough strength to transmit the stresses to the structure without the coil or joint overlapping being deformed.

### DESCRIPTION OF THE INVENTION

The present invention basically comprises a support piece (50) depicted in FIGS. 2 (2A, 2B, 2C and 2D) and 3, designed to be applied in accordance with the individual and specific characteristics of the coverage structure (3).

The support of present invention comprises folds (50a, 50b, 50c) in its cross direction that allow its attachment to the chord, its passage between the joint overlapping and the chord/coil, and that the apparatus supported by it remains above the level of the joint overlapping, avoiding the deformation thereof.

The support of the present invention, in its basic embodiment, is a steel sheet approximately 1 to 3 mm thick, shaped in a typical shape by a hydraulic bender, and has 7 faces:
1 (one) of horizontal that is a base (50a), which is fixed to the chord,
2 (two) inclined (50i1,50i2) with angle compatible with that formed by the faces of the chord—about 45°,
2 (two) vertical faces (50v1,50v2) of enough length to exceed the level of the top of joint overlapping,
2 (two) horizontal upper faces (50h1,50h2) where the apparatus will be fastened over the coverage.

Said faces are depicted in FIGS. 2 (2A, 2B, 2C and 2D) and 3.

Said Support can be embodied in different lengths and with characteristic geometry, depending on its use.

For fastening the Support to the chord and the apparatus to the Support, said Support has holes of various diameters arranged as follows:
4 holes in the horizontal base face (50a), 2 standard holes (50b, 50c) with a diameter of 5 mm and 2 elongated holes (50d, 50e) with a base diameter of 5 mm and elongation in the direction perpendicular to the fold lines with dimensions equal to twice the diameter, 10 mm, as shown in FIGS. 2 (2A, 2B, 2C and 2D) and 3;
8 holes on the upper horizontal faces (50h1, 50h2) (50f, 50g, 50j, 50k, 50m, 50n, 50o, 50p), 4 on each face, and these are divided into 2 groups of 2 holes near the transverse ends of each face. All such holes with a diameter of 5 mm as shown in FIGS. 2 (2A, 2B, 2C and 2D) and 3.

The installation of the piece 50 on the coverage of the initially disclosed system (3) attached to the chord (1) prior to the installation of joint overlapping (8) is as follows.

1. Following the location foreseen in the project, a support (50) is placed over the top chord (1) of the coverage system, aligning its base holes (50a, 50b, 50c, 50d) with the holes (7a, 7b, 7c, 7d) existing on the horizontal faces of chord (104, 109) shown in FIG. 6A. The elongated holes are intended to facilitate the assembly of the Support piece in the chord. Although in the development of piece (50) of present invention, self-tapping screws have been used these may be replaced with rivets or other screws provided they are sized and tested for the desired situation.

2. Through these holes fastening elements are used—Screws or rivets—preferably self-tapping screws, to fasten the Support (50) to the chord (1);

3. The joint overlapping piece is installed in a standard manner, secured by engagement of joint overlapping fastening pieces (8), as shown in FIG. 5, suitable for the system initially disclosed in PI 7805402-8;

4. To the holes of upper horizontal faces (50h1, 50h2) (50e, 50f, 50g, 50h, 50i, 50j, 50l, 50m) are fixed the pieces of the apparatus to be used over the coverage of the initially disclosed system.

### GEOMETRIC ALTERNATIVES

The present invention allows the development of supports having alternative geometric configurations, which may be better suited to a particular purpose or market conditions.

In this way, we can have a smaller support and fastened in only one point for installations with less requirement of resistance, as shown in FIGS. 7A, 7B and 7C.

In keeping with the concept of the present invention, whatever it is, transferring the load of apparatuses over the coverage of the initially disclosed system to its structure, Supports may be developed, which being independent, one for each side of the chord, can act alone or in pairs, specifically suitable for complements of said coverage system, such as walkways, photovoltaic panel holder etc., as shown in FIGS. 8A, 8B, 8C, 8D, 9A and 9B.

### DESCRIPTION OF THE FIGURES

FIG. 1 depicts a perspective view of the structure for coverage of the initially disclosed system (3), showing the chord (1), the diagonals (11), the crossbars (12), the joint overlapping (8), the strap (17), the tile/coverage (15), the counter-diagonals (4) and the shields (9);

FIG. 2A depicts a perspective view of the piece of the present invention (50), emphasizing the faces (50a, 50h₁, 50h₂, 50v₁, 50v₂, 50i₁, 50i₂) and the holes (50b, 50c, 50d, 50e, 50f, 50g, 50j, 50k, 50m, 50n, 50o, 50p);

FIG. 2B depicts a front view of the piece of present invention (50), emphasizing the faces (50a, 50h₁, 50h₂, 50v₁, 50v₂, 50i₁, 50i₂) and the fold lines (50l₁, 50l₂, 50l₃, 50l₄, 50l₅, 50l₆);

FIG. 2C depicts a top view of the piece of present invention (50), emphasizing holes (50b, 50c, 50d, 50e, 50f, 50g, 50j, 50k, 50m, 50n, 50o, 50p);

FIG. 3 depicts a top plan view of the piece of present invention (50), i.e., the sheet before being folded highlighting the fold lines (50l₁, 50l₂, 50l₃, 50l₄, 50l₅, 50l₆) of the piece;

FIG. 4 depicts a perspective view of the coverage structure of the initially disclosed system, with the Support (50) installed prior to positioning the joint overlapping (8);

FIG. 5 depicts a perspective view of Support (50) installed in the chord (1) of the initially disclosed system highlighting the rivet fastening;

FIG. 6A depicts the perspective view of a section of chord 1, with perforations (7a, 7b, 7c, 7d) on the faces 104 and 109, where Supports (50) may be secured;

FIG. 7A depicts a front view of support (50) having specific geometry installed in an upper chord (1) of a beam of the initially disclosed system with the joint overlapping (8) placed over both;

FIG. 7B depicts a perspective view of the assembly of Support (50), having specific geometry, maintaining the initial concept of the invention, highlighting its fastening through rivet;

FIG. 7C depicts a perspective view of a Support (50), having specific geometry, already mounted on the chord (1) of the initially disclosed system;

FIGS. 8A and 8B depict front views of a support (50), having specific geometry, installed in an upper chord (1) of a beam of the initially disclosed system, with the joint overlapping (8) placed over both and with pieces of apparatuses attached thereto;

FIGS. 8C and 8D depict perspective views of a support (50), having specific geometry, installed in an upper chord (1) of a beam of the initially disclosed system with the joint overlapping (8) placed over both and with pieces of apparatuses attached thereto;

FIGS. 9A and 9B depict perspective views of a support (50), having specific geometry, installed in an upper chord (1) of a beam of the initially disclosed system with the joint overlapping (8) placed over both highlighting the possibility of the supports being connected longitudinally or transversally for specific purposes of continuous apparatuses (walkways, photovoltaic plates, lifelines, etc.).

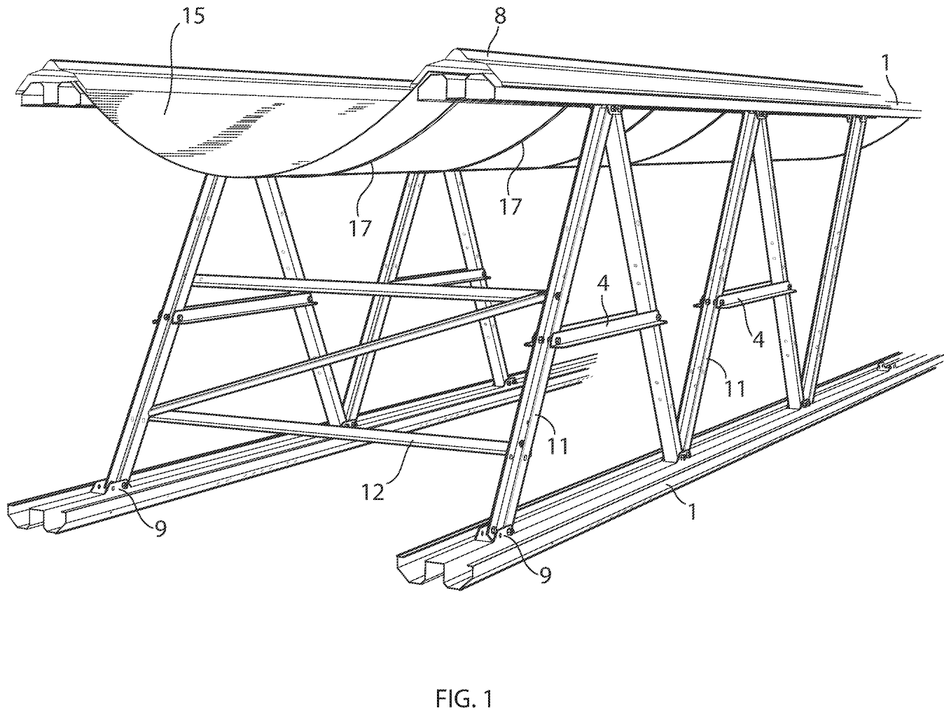

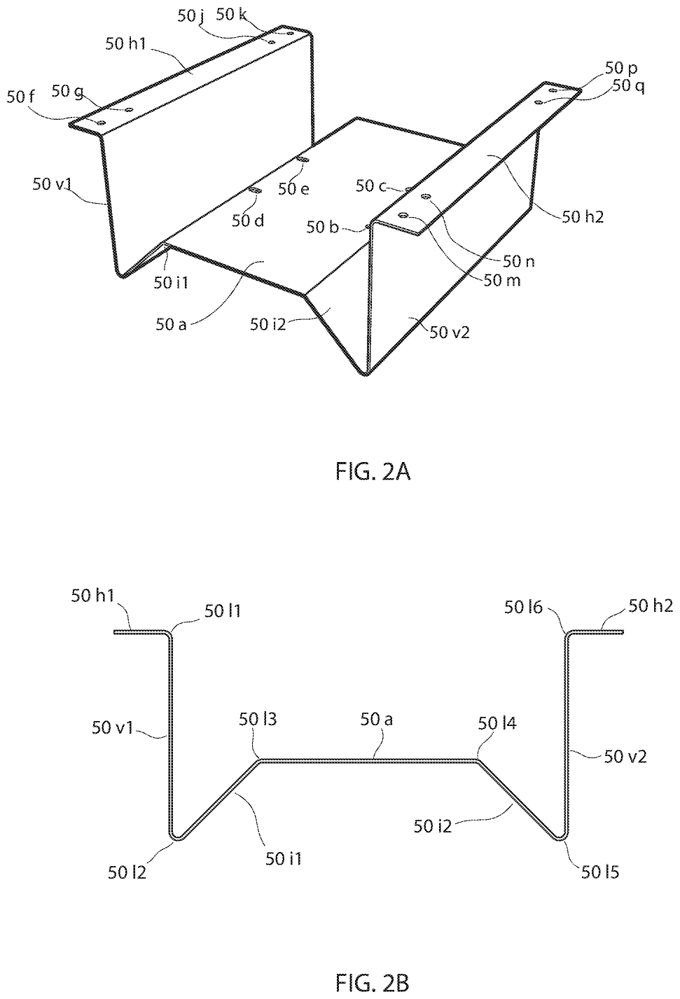

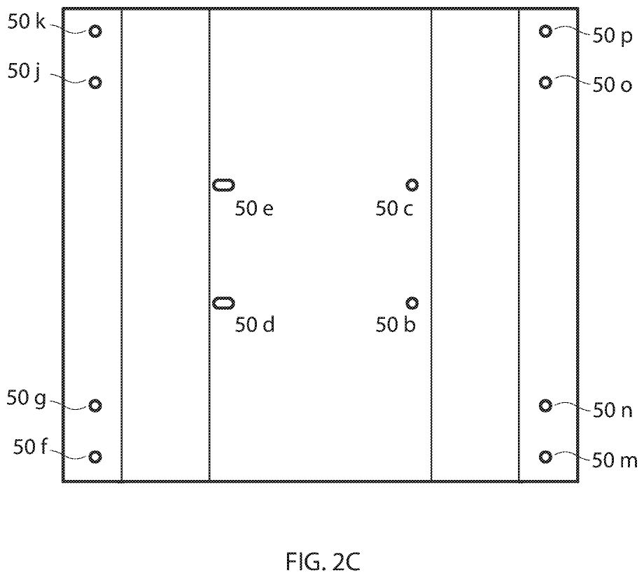

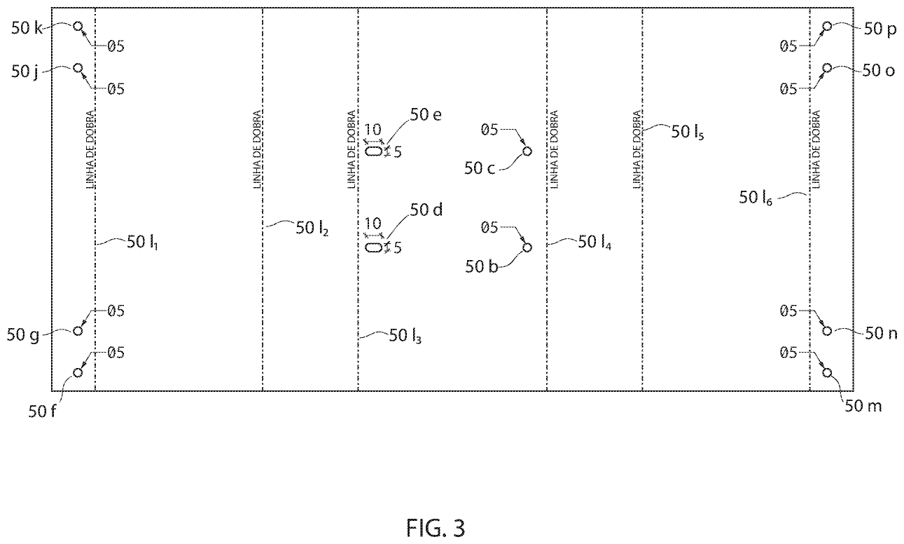

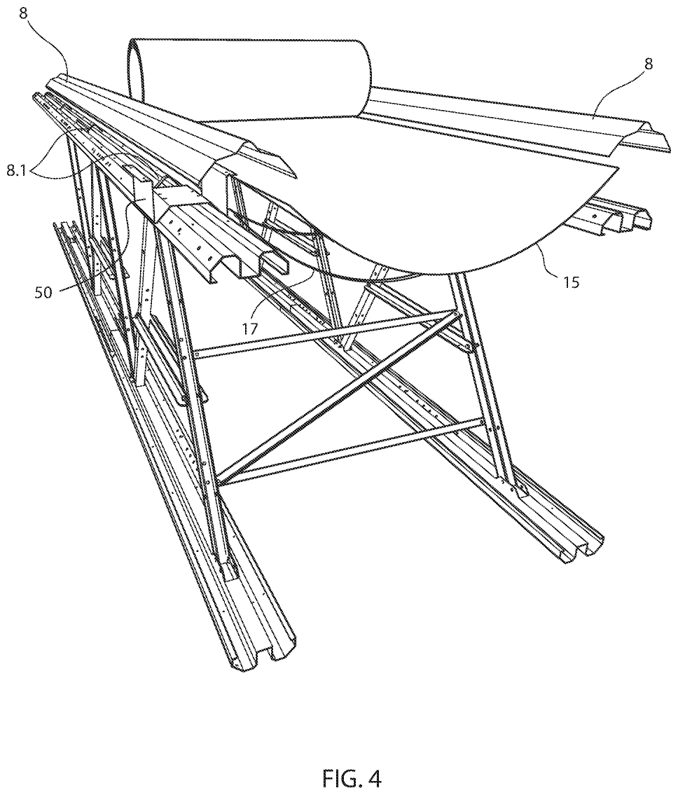

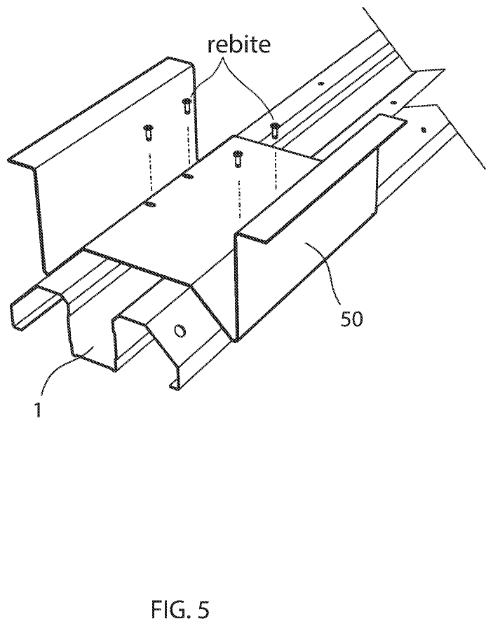

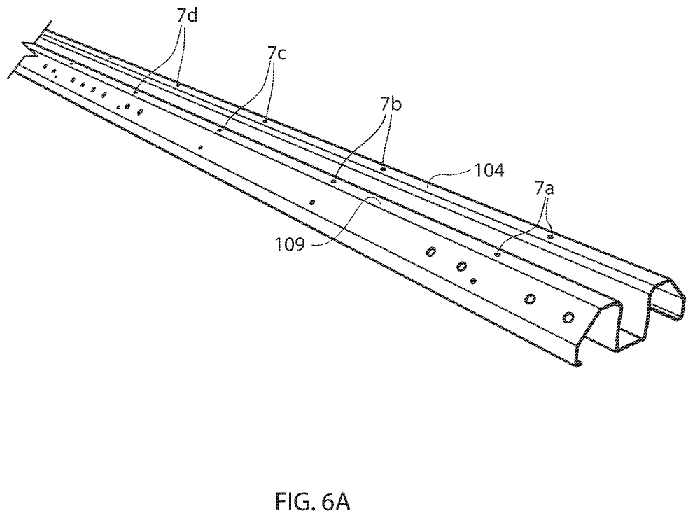

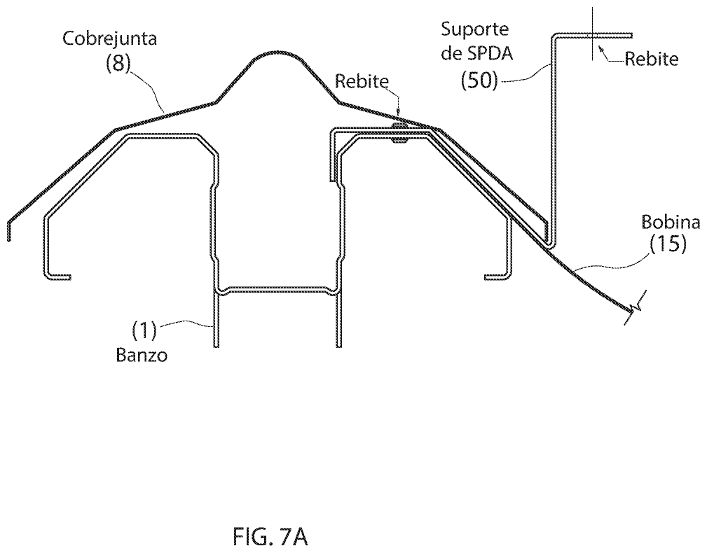

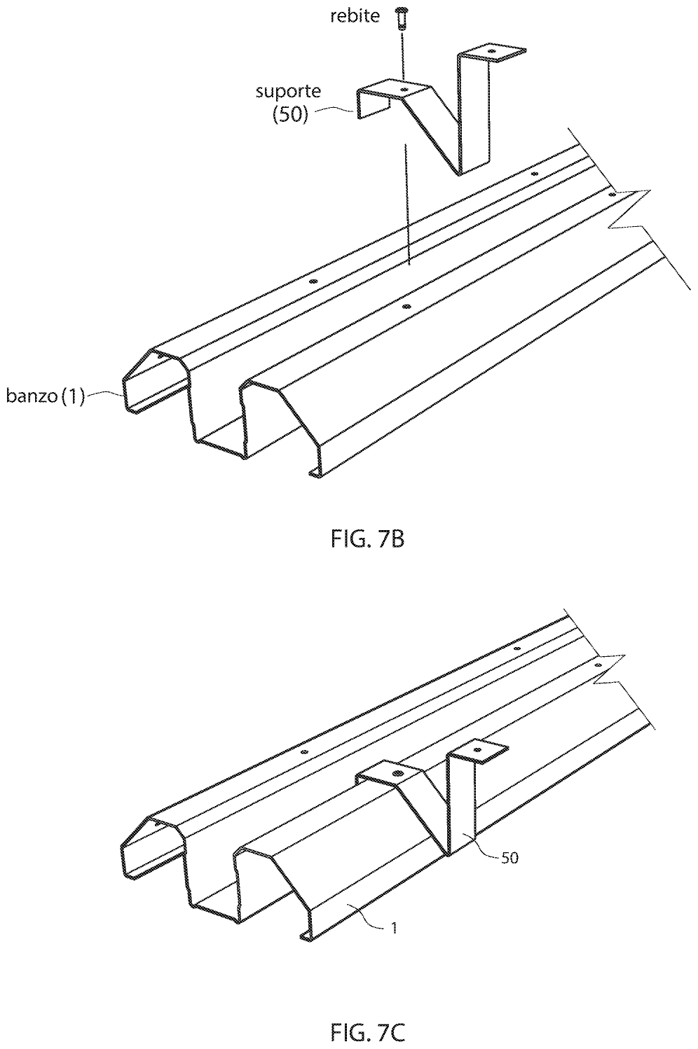

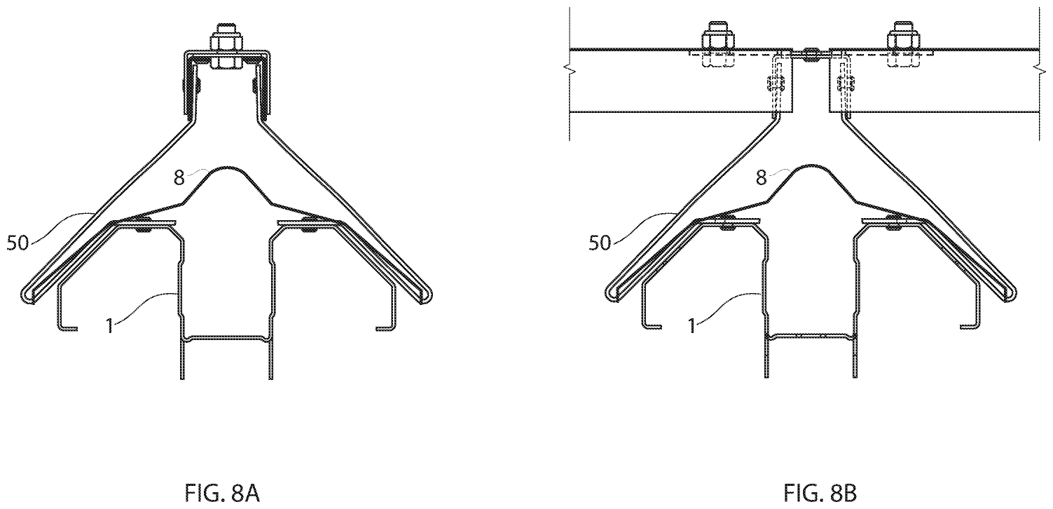

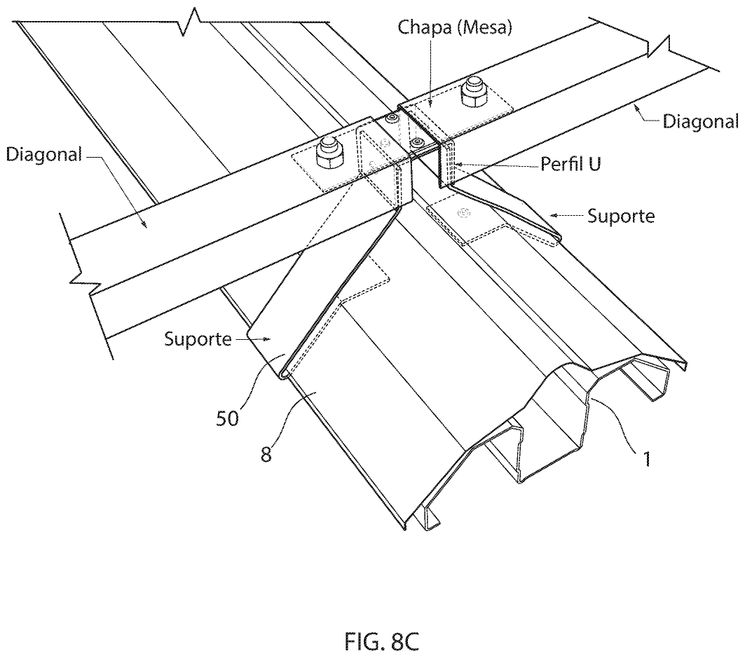

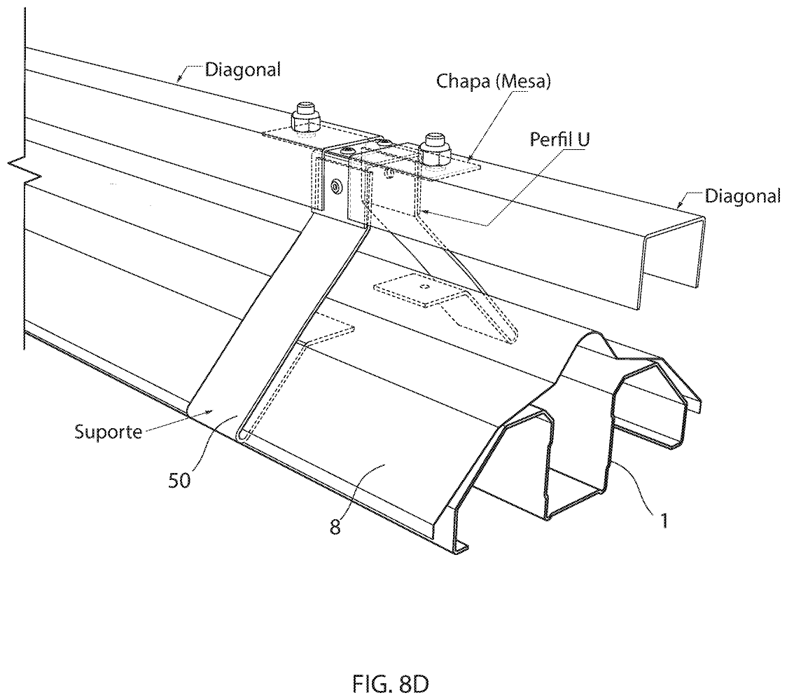

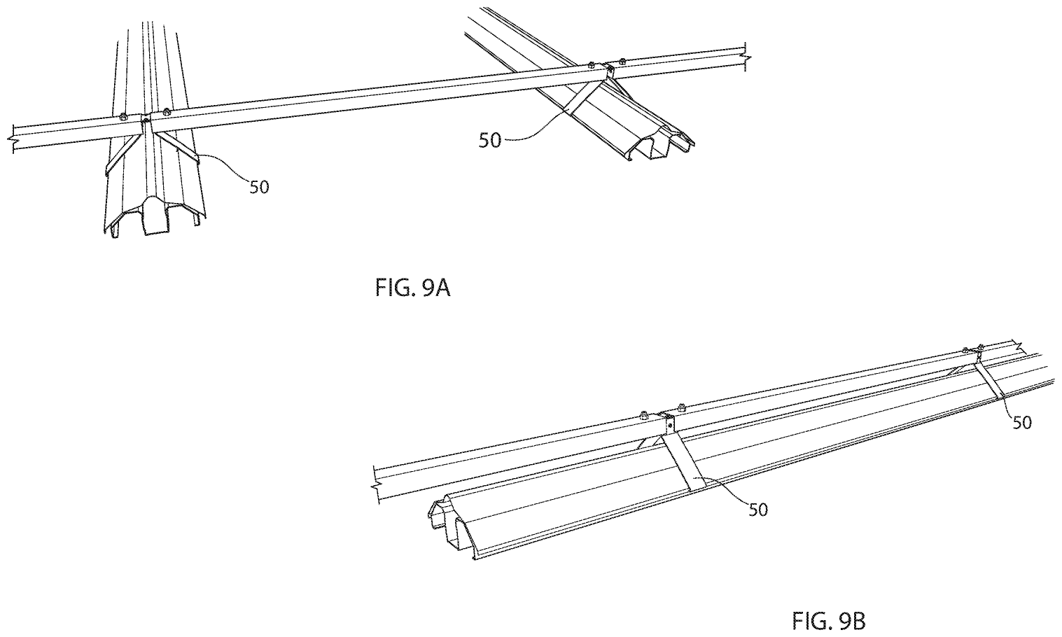

### DESCRIPTION OF THE ELEMENTS OF THE FIGURES

For a better understanding of the present invention, the following list of elements and/or components is presented:
1—chord
3—structure (chords+diagonals+crosspieces)
4—counter-diagonal
7a—holes 5 mm diameter on the face of chord (1)
7b—holes 5 mm diameter on the face of chord (1)
7c—holes 5 mm diameter on the face of chord (1)
7d—holes 5 mm diameter on the face of chord (1)
8—joint overlapping
11—diagonal
12—crosspiece
15—coil
17—tape
50—Support
50a—horizontal base of support
50b—standard hole 5 mm diameter in the base of Support
50c—standard hole 5 mm diameter in the base of Support
50d—elongated hole 5×10 mm of base of Support
50e—elongated hole 5×10 mm of base of Support
50f—standard hole 5 mm diameter on face 50h1
50g—standard hole 5 mm diameter on face 50h1
50j—standard hole 5 mm diameter on face 50h1
50k—standard hole 5 mm diameter on face 50h1
50m—standard hole 5 mm diameter on face 50h2
50n—standard hole 5 mm diameter on face 50h2
50o—standard hole 5 mm diameter on face 50h2
50p—standard hole 5 mm diameter on face 50h2
50l₁—flap fold line of Support
50l₂—flap fold line of Support
50l₃—flap fold line of Support
50l₄—flap fold line of Support
50l₅—flap fold line of Support
50l₆—flap fold line of Support

1. Piece or assembly of pieces joined or not, having a shape conveniently proper for fastening to the base structure, in defined positions, in a modular way, such that it acts as a support of apparatuses located over the coverage, such as walkways, equipment, lifelines, SPDA systems, power generating systems through voltaic panels, etc. without the need for drilling holes for that or that existing screws of the coverage system are used.

2. Piece or assembly of pieces joined or not, having a shape and resistance proper for transferring loads of apparatuses placed over the coverage to the coverage structure without causing perforations or damage to the coverage sheets (tiles).

3. Piece or assembly of pieces having geometry and inertia compatible with the need to protect the plates of coverages from weights of apparatuses placed over the coverage.

4. A support for securing an apparatus to a structure, the support comprising:
a base having a hole extending therethrough, the base configured to engage and rest on an upper surface of a corresponding portion of the structure;
an inclined portion extending downwardly from a first side of the base;
an upward extending portion extending from the inclined portion; and
an upper mounting portion extending from the upward extending portion, the upper mounting portion configured to engage and support the apparatus to be mounted to the structure.

5. The support of claim 4, wherein the inclined portioned of the support is configured to engage and rest on an angle portion of the corresponding portion of the structure.

6. The support of claim 4, wherein the upward extending portion extends in a vertical direction.

7. The support of claim 4, wherein the upper mounting portion extends is in a horizontal direction.

8. The support of claim 4, wherein, the upper mounting portion extends in a vertical direction.

9. The support of claim 4, wherein the base includes a plurality of holes and the upper mounting portion includes a plurality of holes.

10. The support of claim 4, wherein the hole in the base is elongated.

11. The support of claim 4, wherein the support is formed from a single flat sheet of metal.

12. The support of claim 4, further comprising:
a second inclined portion extending downwardly from a second, opposite side of the base;
a second upward extending portion extending from the second inclined portion; and
a second upper mounting portion extending from the second upward extending portion, the second upper mounting portion configured to engage and support the apparatus to be mounted to the structure.

13. An assembly comprising:
a structure having an elongated chord, the elongated chord having an upper surface with a substantially horizontal first portion and an inclined second portion; and
a support for securing an apparatus to the elongated chord of the structure, the support comprising:
a base having a hole extending therethrough, the base engaging the first portion of the upper surface of the elongated chord;
an inclined portion extending from a first side of the base;
an upward extending portion extending from the inclined portion; and
an upper mounting portion extending from the upward extending portion, the upper mounting portion configured to engage and support the apparatus to be mounted to the structure.

14. The assembly of claim 13, further comprising:
a fastener extending through the hole in the base of the support for securing the support to the elongated chord.

15. The assembly of claim 13, wherein the inclined portion of the support engages and rests on the inclined second portion of the upper surface of the elongated chord.

16. The assembly of claim 13, wherein the upward extending portion extends in a vertical direction.

17. The assembly of claim 13, wherein the upper mounting portion extends in a horizontal direction.

18. The assembly of claim 13, wherein the base includes a plurality of holes and the upper mounting portion includes a plurality of holes.

19. The assembly of claim 13, wherein the support is formed from a single flat sheet of metal.

20. The assembly of claim 13, further comprising:
a second inclined portion extending downwardly from a second, opposite side of the base;
a second upward extending portion extending from the second inclined portion; and
a second upper mounting portion extending from the second upward extending portion, the second upper mounting portion configured to engage and support the apparatus to be mounted to the structure.
